(19) United States
(12) Patent Application Publication
(10) Pub. No.: US 2003/0224627 A1
(43) Pub. Date: Dec. 4, 2003

(54) Probe card, probe card manufacturing method, and contact

(76) Inventors: Hidenori Kitazume, Tokyo (JP); Kouichi Wada, Tokyo (JP); Wataru Narazaki, Tokyo (JP)

Correspondence Address: ROSENTHAL & OSHA L.L.P., 1221 MCKINNEY AVENUE, SUITE 2800, HOUSTON, TX, 77010, US

(21) Appl. No.: 10/447,783

(22) Filed: May 29, 2003

(30) Foreign Application Priority Data
May 30, 2002 (JP) 2002-157258

(51) Int. Cl. H01R 12/00

(52) U.S. Cl. 439/55

(57) ABSTRACT

A probe card including a minute and highly accurate probe pin, including a probe pin electrically connecting with the electronic device; and a wiring substrate including a wiring electrically connecting with the probe pin. The probe pin includes: a first end electrically connecting with the wiring; a contact section extending from the first end to a direction away from the wiring substrate, the contact section being formed to oppose the wiring substrate and electrically connecting with the electronic device; a second end extending from the contact section and electrically connecting with the wiring; and a hollow section formed in an area sandwiched between the wiring substrate and the contact section.

This patent application claims priority from a Japanese patent application No. 2002-157258 filed on May 30, 2002, the contents of which are incorporated herein by reference.

### BACKGROUND OF THE INVENTION

1. Field of the Invention

The present invention relates to a probe card, a probe card manufacturing method, and a contact. More particularly, the present invention relates to a probe card electrically connecting with an electronic device.

2. Description of Related Art

In recent years, since pitch of electrodes of an IC has been shortened, demands are increasing for miniaturizing and increasing accuracy of probe pin of a test apparatus for testing the IC. As a conventional minute probe pin, a tungsten probe pin, a membrane probe pin, and the like are known.

However, there are problems that it is not easy to process the tungsten probe, and the membrane probe pin is easily deformed by contact with a device under test. Therefore, it is difficult to provide a probe card having a minute and highly accurate probe pin.

### SUMMARY OF THE INVENTION

Therefore, it is an object of the present invention to provide a probe card, a probe card manufacturing method, and contact which can solve the foregoing problem. The above and other objects can be achieved by combinations described in the independent claims. The dependent claims define further advantageous and exemplary combinations of the present invention.

Therefore, according to the first aspect of the present invention, there is provided a probe card electrically connecting with an electronic device. The prove card includes: a probe pin electrically connecting with the electronic device; and a wiring substrate including a wiring electrically connecting with the probe pin. The probe pin includes: a first end electrically connecting with the wiring; a contact section extending from the first end to a direction away from the wiring substrate, the contact section being formed to oppose the wiring substrate and electrically connecting with the electronic device; a second end extending from the contact section and electrically connecting with the wiring; and a hollow section formed in an area sandwiched between the wiring substrate and the contact section.

The probe pin may include: a conductive layer including the first end, the contact section and the second end, which are integrated together; and an elastic conductive layer substantially covering a back surface of a surface opposing the wiring substrate of the conductive layer.

According to the second aspect of the present invention, there is provided a probe card manufacturing method of manufacturing a probe card including a probe pin electrically connecting with an electronic device, and a wiring substrate including a wiring electrically connecting with the probe pin. The prove card manufacturing method including steps of: forming a recess on a surface of the formation substrate on which the probe pin is formed; forming a conductive layer in the recess and a portion in the vicinity of the recess on the surface of the formation substrate; bonding the wiring to the conductive layer formed on the surface of the formation substrate; and removing the formation substrate.

Moreover, the probe card manufacturing method may further include a step of forming an elastic conductive layer in the recess, and the conductive layer may be formed on the elastic conductive layer in the conductive layer formation step. The plurality of recesses may be formed in the recess formation step, and the plurality of mutually separated conductive layers, which respectively correspond to the plurality of recesses, may be formed in the conductive layer formation step.

According to the third aspect of the present invention, there is provided a contact electrically connecting a wiring substrate including a wiring with a conductor. The contact includes: a first end electrically connecting with the wiring; a contact section extending from the first end to a direction away from the wiring substrate, the contact section being formed to oppose the wiring substrate and electrically connecting with the conductor; a second end extending from the contact section and electrically connecting with the wiring; and a hollow section formed in an area sandwiched between the wiring substrate and the contact section.

According to the fourth aspect of the present invention, there is provided a probe card including a probe pin electrically connecting with an electronic device. The probe pin includes: a contact section electrically connecting with the electronic device; and an elastic section, having elasticity in a direction in which the contact section contacts the electronic device, and holding the contact section, the elastic section being made of silicon.

Moreover, the probe card may further include a wiring substrate including a wiring electrically connecting with the probe pin, and the elastic section may include an end, and another end, which is spaced apart from the wiring substrate. The probe pin may include: an attachment section extending from the end of the elastic section substantially parallel with the wiring substrate, and connecting with the wiring substrate; and a depressing section extending from the other end of the elastic section to a direction opposite from the attachment section substantially parallel with the wiring substrate, the depressing section holding the contact section on a back surface of a surface opposing the wiring substrate. The probe card may include a plurality of probe pins.

According to the fifth aspect of the present invention, there is provided a probe card including a probe pin electrically connecting with an electronic device. The probe pin includes: a plurality of contact sections electrically connecting with the electronic device; and an elastic section, having elasticity in a direction in which the plurality of contact sections contact the electronic device, and holding the plurality of contact sections.

According to the sixth aspect of the present invention, there is provided a probe card manufacturing method of manufacturing a probe card including: a contact section electrically connecting with the electronic device; and an elastic section, having elasticity in a direction in which the contact section contacts the electronic device, and holding the contact section. The probe card manufacturing method including steps of: preparing a the silicon substrate including a front substrate surface and a back substrate surface; forming a front surface recess on the front substrate surface by etching the silicon substrate from the front substrate surface; forming a back surface recess on the back substrate surface by etching the silicon substrate from the back substrate surface, and forming the elastic section sandwiched between a side of the front surface recess and a side of the back surface recess; and forming the contact section at a portion corresponding to bottom of the front surface recess on the back substrate surface. In this case, the front surface etching step and the back surface etching step are performed simultaneously.

Moreover, The probe card may further include a wiring substrate including a wiring electrically connecting with the probe pin, and the probe card manufacturing method may further include steps of: forming a through tube penetrating from bottom of the back surface recess to the front substrate surface; forming a feedthrough wiring in the through tube; forming a connection wiring provided over the back substrate surface from a portion corresponding to bottom of the front surface recess to the bottom of the back surface recess, the connection wiring connecting the contact section with the feedthrough wiring electrically; and connecting electrically the feedthrough wiring with the wiring of the wiring substrate. A plurality of contact sections may be formed in the contact section formation step.

According to the seventh aspect of the present invention, there is provided a probe card manufacturing method of manufacturing a probe card including a probe pin electrically connecting with an electronic device. The probe card manufacturing method including steps of: forming a recess on a surface of a formation substrate on which the probe pin is formed; forming a conductive layer from a portion in the vicinity of the recess to bottom of the recess on the surface of the formation substrate; and exposing the conductive layer formed on the bottom of the recess by etching the formation substrate from a back surface. A plurality of the conductive layers, which are separated mutually, may be formed in the conductive layer formation step. The probe card may further include a wiring substrate including a wiring electrically connecting with the probe pin, and the probe card manufacturing method may further include a step of bonding the conductive layer formed in the vicinity of the recess to the wiring.

The summary of the invention does not necessarily describe all necessary features of the present invention. The present invention may also be a sub-combination of the features described above.

### BRIEF DESCRIPTION OF THE DRAWINGS

FIG. 1A to FIG. 1H are drawings exemplary showing a probe card manufacturing method according to a first embodiment of the present invention. Specifically, FIG. 1A is a cross sectional view of a formation substrate in an etching mask formation step, FIG. 1B is a top view of the formation substrate in the etching mask formation step, FIG. 1C is a drawing explaining an elastic conductive layer formation step, FIG. 1D is a drawing explaining a conductive layer formation step, FIG. 1E is a drawing explaining a bonding step, FIG. 1F is a drawing explaining a removal step, FIG. 1G is a top view of a probe card according to the present embodiment, and FIG. 1H is a top view of the probe card according to another example of the present embodiment.

FIG. 2A and FIG. 2B are drawing exemplary showing other examples of a probe pin according to the present embodiment. Specifically, FIG. 2A is a drawing exemplary showing the probe pin including a substantially semi-spherical metal layer and a metallic glass layer, and FIG. 2B is a drawing exemplary showing the probe pin including a substantially conical metal layer and a metallic glass layer.

FIG. 3 is an exploded perspective view exemplary showing a probe card according to a second embodiment of the present invention.

FIG. 4A to FIG. 4K are drawings exemplary showing a probe card manufacturing method of manufacturing the probe card according to the present embodiment. Specifically, FIG. 4A is a drawing explaining a preparation step, FIG. 4B is a drawing explaining a double-sided etching mask formation step, FIG. 4C is a drawing explaining a double-sided etching step, FIG. 4D is a drawing explaining a projection mask formation step, FIG. 4E is a drawing explaining a projection etching step, FIG. 4F is a drawing explaining a feedthrough mask formation step, FIG. 4G is a drawing explaining a feedthrough etching step, FIG. 4H is a drawing explaining an insulating layer formation step, FIG. 4I is a drawing explaining an overall metal layer formation step, FIG. 4J is a drawing explaining a feedthrough wiring formation step, and FIG. 4K is a drawing explaining a pattern formation step.

FIG. 5A and FIG. 5B are drawings showing other examples of the probe pin according to the present embodiment. FIG. 5A is a drawing exemplary showing the probe pin having a curved connection wiring, and FIG. 5B is a drawing exemplary showing the probe pin, where an elastic section is substantially perpendicular to a depressing section and an attachment section.

FIG. 6A to FIG. 6G are drawings exemplary showing a probe card manufacturing method according to a third embodiment of the present invention. FIG. 6A is a cross sectional view of a formation substrate in a recess formation step, FIG. 6B is a drawing explaining a projection formation step, FIG. 6C is a drawing explaining a conductive layer formation step, FIG. 6D is a drawing explaining a removal step, FIG. 6E is a drawing explaining a bonding step, FIG. 6F is a cross sectional view of a probe card according to the present embodiment, and FIG. 6G is a top view of the probe card according to the present embodiment.

FIG. 7A and FIG. 7B are drawings showing other examples of the probe card according to the present embodiment. FIG. 7A is a drawing exemplary showing the probe card having a curved extending section, and FIG. 7B is a drawing exemplary showing the probe card having a plurality of attachment sections and a plurality of extending sections corresponding to a contact section.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

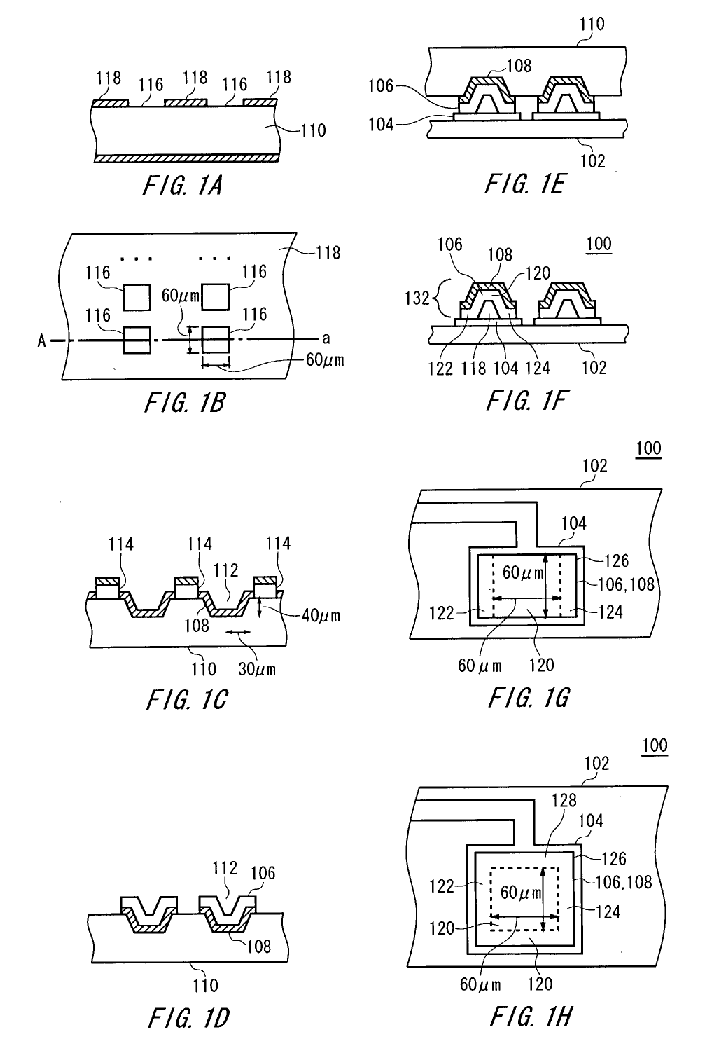

FIG. 1A to FIG. 1H are drawings exemplary showing a probe card manufacturing method according to a first embodiment of the present invention. In the probe card manufacturing method according to the present embodiment, a probe card electrically connecting with an electronic device is manufactured. By the probe card manufacturing method, the probe card is manufactured including a wiring substrate having a probe pin electrically connecting with the electronic device and wiring electrically connecting with the probe pin. The probe card manufacturing method includes a recess formation step, an elastic conductive layer formation step, a conductive layer formation step, a bonding step, and a removal step.

FIG. 1A and FIG. 1B are drawings explaining the recess formation step. In the recess formation step a recess is formed on a surface of a formation substrate 110 in which a probe pin is formed. In the present embodiment, the plurality of recesses are formed in the recess formation step. The plurality of recesses are formed in the recess formation step by etching predetermined etching areas 116 on the surface of the formation substrate 110. In the present embodiment, the recess formation step includes an etching mask formation step and an etching step.

FIG. 1A is a cross sectional view of the formation substrate 110 in the etching mask formation step. In the etching mask formation step, an etching mask 118 is formed on a part of the surface of the formation substrate 110 for masking an area other than the etching areas 116. In the etching mask formation step, the etching mask 118 is formed using photo lithography technology. In the present embodiment, the etching mask 118 is formed on the surface of the formation substrate 110, which is a silicon substrate, in the etching mask formation step. In the etching mask formation step, a silicon oxide film (SiOx oxide film) is formed as the etching mask 118. In the etching mask formation step, the silicon oxide film is formed by thermally oxidizing the surface of the formation substrate 110. In the etching mask formation step, portions corresponding to the etching areas 116 are removed from the silicon oxide film formed on the whole surface by photo lithography technology. In the etching mask formation step, it is preferable that a silicon oxide film is also formed on the back side of the formation substrate 110. It is also preferable that plane directions of the surface of the formation substrate 110 are [100].

In the etching step, the etching areas 116 are etched using the etching mask 118 as the mask. It is preferable that the etching areas 116 are etched by anisotropic etching in the etching step. In the present embodiment, the etching is done by KOH etching reagent in the etching step. In another example, the etching step is performed by isotropic etching. In the etching step, the etching areas 116 are etched to a depth of 40 micrometers. In the etching step, it is preferable to form the recess having a bottom section substantially parallel with the surface of the formation substrate 110. In the present embodiment, the recess, which is formed in the etching step, includes a bottom section, of which the area is smaller than the etching areas 116, and a side section connecting the bottom section and the surface of the formation substrate 110.

FIG. 1B is a top view of the formation substrate 110 in the etching mask formation step. In the present embodiment, the etching mask 118 is formed for masking the portion other than the plurality of etching areas 116 in the etching mask formation step. Each of the plurality of etching areas 116 is a square about 60 micrometers on a side. In addition, FIG. 1A is a cross sectional view taken along the alternate long and short dash line A-a in FIG. 1B.

FIG. 1C is a drawing explaining an elastic conductive layer formation step. In the elastic conductive layer formation step, an elastic conductive layer is formed in a recess 112. In the present embodiment, a metallic glass layer 108 is formed as the elastic conductive layer in the elastic conductive layer formation step. For example in the elastic conductive layer formation step, a PbCuSi layer is formed as the metallic glass layer 108. In the present embodiment, a plurality of mutually separated metallic glass layers 108, which correspond to a plurality of recesses respectively, are formed in the elastic conductive layer formation step. The elastic conductive layer formation step includes an elastic conductive layer mask formation step and a layer formation step. In the elastic conductive layer mask formation step, a layer formation mask 114 is formed on the surface of the formation substrate 110, the formation mask masking the portion other than the predetermined layer formation area. In the present embodiment, the layer formation area includes the recess 112 and an area in the vicinity of the recess 112 on the surface of the formation substrate 110. The layer formation mask 114 is a resist film.

In the layer formation step, the metallic glass layer 108 is formed on the layer formation area using the layer formation mask 114 as the mask. In the present embodiment, the metallic glass layer 108 is formed by sputtering in the layer formation step. In the layer formation step, the metallic glass layer 108 with thickness of about five micrometers is formed. In the layer formation step, the layer formation mask 114 is removed after the metallic glass layer 108 is formed.

FIG. 1D is a drawing explaining the conductive layer formation step. In the conductive layer formation step, a conductive layer is formed on the metallic glass layer 108. In the conductive layer formation step, the conductive layer is formed in the recess 112 and an area in the vicinity of the recess 112 on the surface of the formation substrate 110. In the present embodiment, a metal layer 106 is formed as the conductive layer in the conductive layer formation step. For example, a layer made of gold (Au) is formed as the metal layer 106 in the conductive layer formation step. Moreover in the present embodiment, a plurality of mutually separated conductive layers are formed corresponding to the plurality of recesses.

The conductive layer formation step includes an overall metal layer formation step, a plating mask formation step, a plating step, and an overall metal layer removal step. In the overall metal layer formation step, an overall metal layer (not shown), which is used for an electrode in the plating step, is formed on the whole surface of the recess 112 and the formation substrate 110. In the overall metal layer formation step, the overall metal layer with thickness of about 0.1-0.3 micrometer is formed by sputtering for example.

In the plating mask formation step, the plating mask is formed for masking areas other than a predetermined plating area on the overall metal layer. In the plating mask formation step, the plating mask is formed by a resist film. The plating area is an area on which the metal layer 106 is formed. The plating area is an area substantially the same area as the layer formation area in the elastic conductive layer formation step. Alternatively, the plating area is an area substantially the same area as the area on which the metallic glass layer 108 is formed.

In the plating step, the metal layer 106 is formed on the plating area by plating. In the present embodiment, electrolysis plating is done with the plating mask as the mask in the plating step. In the plating step, the electrolysis plating is done using the overall metal layer as the electrode. In the present embodiment, the metal layer 106 made of gold (Au) with thickness of about two micrometers is formed by plating in the plating step. In the plating step, the plating mask is removed after the plating with gold is finished.

In the overall metal layer removal step, a part of the overall metal layer is removed. In the present embodiment, a portion corresponding to the plating mask among overall metal layer is removed in the overall metal layer removal step. In the overall metal layer removal step, the portion is removed by ion milling.

In another example, the conductive layer is formed by sputtering in the conductive layer formation step. In this case, the conductive layer is formed in the conductive layer formation step using the layer formation mask 114 used in the elastic conductive layer formation step as the mask.

FIG. 1E is a drawing explaining the bonding step. In the bonding step, the wiring 104 of the wiring substrate 102 is bonded to the metal layer 106 formed on the surface of the formation substrate 110. In the bonding step, the wiring 104 is bonded to the metal layer 106 by thermo compression bonding.

FIG. 1F is a drawing explaining the removal step. In the removal step, the formation substrate 110 is removed. For example, the formation substrate 110 is removed by ICP etching in the removal step. In the removal step, a probe card 100 is formed by removing the formation substrate 110. In the present embodiment, a probe pin 132 of the probe card 100 includes a first end 122, a contact section 120, and a second end 124. In the present embodiment, the probe pin 132 further includes a hollow section 118 formed in an area sandwiched between the wiring substrate 102 and the contact section 120.

The first end 122 electrically connects with the wiring 104. The contact section 120 extends from the first end 122 to a direction away from the wiring substrate 102, provided so as to oppose the wiring substrate 102, and electrically connects with the electronic device. The second end 124 is extended from the contact section 120, and electrically connects with the wiring 104. Moreover, the hollow section 118 is formed in an area sandwiched between the wiring 104 and the contact section 120.

In the present embodiments, the probe pin 132 includes the metal layer 106 and the metallic glass layer 108. The metal layer 106 is an integrated conductive layer including the first end 122, the contact section 120, and the second end 124. The metallic glass layer 108 is an elastic conductive layer which substantially covers the back side of the surface opposing the wiring substrate 102 of the metal layer 106.

FIG. 1G is a top view of the probe card 100 according to the present embodiment. In the present embodiment, the probe pin 132 electrically connects with the wiring 104 at the first end 122 and the second end 124. In the present embodiment, the first end 122 includes one edge of the metal layer 106. The first end 122 is a substantial rectangle, of which the edge is one side of the rectangle. Moreover, the second end 124 includes another edge of the metal layer 106. The second end 124 is a substantial rectangle, of which the other edge is one side of the rectangle.

FIG. 1H is a top view of the probe card according to another example. In this example, the probe pin further includes a third end 126 and a fourth end 128. The probe pin electrically connects with the wiring 104 at the first end 122, the second end 124, the third end 126, and the fourth end 128. Each of the third end 126 and the fourth end 128 is a substantial rectangle, of which a part of the edges of the metal layer 106 is one side of the rectangle.

According to the present embodiment, the probe card having a minute and highly accurate probe pin is manufactured by manufacturing a probe pin with photo lithography technology towards a silicon substrate. Moreover, according to the present embodiment, the probe card having the probe pin elastically contacting with the IC, which is the electronic device under test, is manufactured. Moreover, according to the present embodiment, since the portion in contact with the electronic device of the probe pin is made of metallic glass, distortion of the probe pin due to the contact with the electrode of the IC is prevented. Moreover, the probe pin which has desired height is manufactured by regulating the amount of the etching in the recess formation step. Moreover, the probe pin having desired shape is manufactured by regulating the shape of the etching in the recess formation step. Furthermore, according to the present embodiment, a plurality of probe pins of the probe card are manufactured collectively.

In addition, according to the present embodiment, the probe pin is an example of a contact which electrically connects the wiring substrate having the wiring with the conductor. The contact includes: a first end electrically connecting with the wiring; a contact section extending from the first end to the opposite direction from the wiring substrate, opposing the wiring substrate, and electrically connecting with the conductor; a second end extending from the contact section and electrically connecting with the wiring of the wiring substrate; and a hollow section formed in the area sandwiched by the wiring substrate and the contact section.

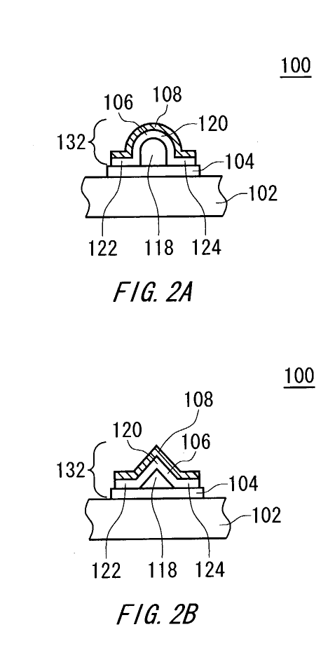

FIGS. 2A and 2B show other examples of the probe card 100 according to the present embodiment. In FIGS. 2A and 2B, the component which bears the same reference numeral as FIGS. 1A-1H has the similar function to that of the component in FIGS. 1A-1H. In the example shown in FIG. 2A, the probe pin 132 includes the substantially semi-spherical metal layer 106 and the metallic glass layer 108. In this example, in the etching step of the recess formation step, the recess is formed which includes a surface corresponding to the substantially semi-spherical shape by isotropic etching. The metallic glass layer 108 is formed on the surface of the recess.

Moreover, in the example shown in FIG. 2B, the probe pin 132 includes the substantially conical metal layer 106 and the metallic glass layer 108. In this example, in the etching step of the recess formation step, the recess is formed which includes a substantially conical surface by anisotropic etching with strong anisotropy. The metallic glass layer 108 is formed on the surface of the recess. Also in these cases, the probe card having a minute and highly accurate probe pin is manufactured.

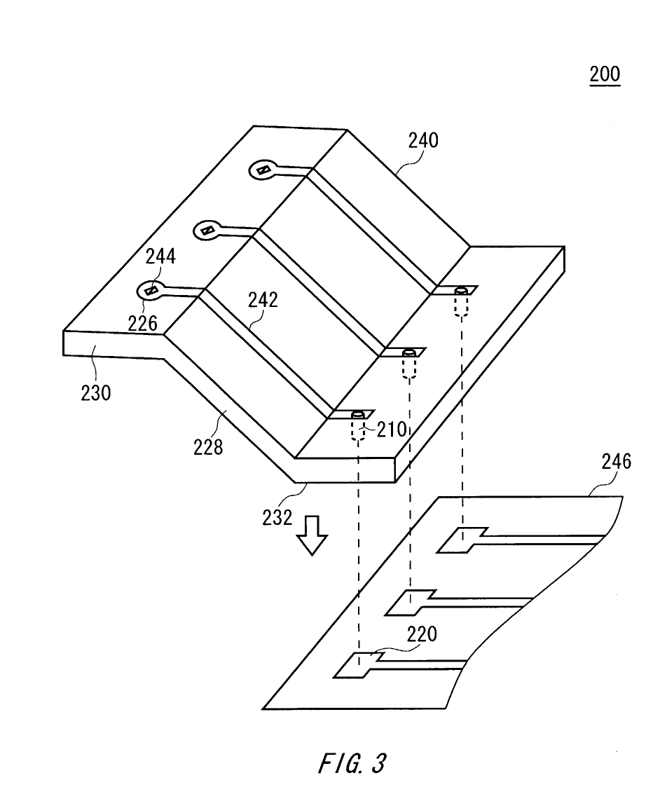

FIG. 3 is an exploded perspective view exemplary showing a probe card 200 according to a second embodiment of the present invention. In the present embodiment, the probe card 200 includes a wiring substrate 246 including a probe pin 240 electrically connecting with the electronic device, and wirings 220 electrically connecting with the probe pin 240. Alternatively, the probe card includes a plurality of probe pins 240.

The probe pin 240 includes a contact section 226, an elastic section 228, an attachment section 232, a depressing section 230, a feedthrough wiring 210, and a connection wiring 242. In the present embodiment, the probe pin 240 includes the elastic section 228, the attachment section 232, and the depressing section 230 consisting of silicon. The probe pin 240 includes the elastic section 228, the attachment section 232, and the depressing section 230 which are integrated together. Moreover, the probe pin 240 includes a plurality of connection wirings 242 corresponding to a plurality of contact sections 226, and a plurality of feedthrough wirings 210 corresponding to a plurality of contact sections 242.

The contact section 226 electrically connects with the electronic device. In the present embodiment, the contact section 226 includes a projection 244, which is a portion in contact with the electronic device. The elastic section 228 has elasticity in the direction in which the contact section 226 contacts with the electronic device, and holds the plurality of contact sections 226 by holding the depressing section 230. In the present embodiment, the elastic section 228 is formed of silicon. The elastic section 228 is a tabular object including a surface which is inclined to the surface of the wiring substrate 246. The elastic section 228 includes an end, and another end which is spaced apart from the wiring substrate 246.

The attachment section 232 extends from the end of the elastic section 228 substantially parallel with the wiring substrate 246, and connects with the wiring substrate 246. In the present embodiment, the attachment section 232 is a tabular object substantially parallel with the wiring substrate 246. The attachment section 232 includes a through tube penetrating from the surface opposing the wiring substrate 246 to the back surface of the surface. The feedthrough wiring 210 is provided at the through tube, and electrically connects with the wiring 220 of the wiring substrate 246.

The depressing section 230 extends from the other edge of the elastic section 228 to the direction opposite from the attachment section 232 and substantially parallel with the wiring substrate 246. The depressing section 230 holds the contact section 226 on the back side of the surface opposing the wiring substrate 246. The connection wiring 242 is provided from the depressing section 230 to the attachment section 232, and connects the contact section 226 with the feedthrough wiring 210 electrically. The connection wiring 242 is integrated with the contact section 226 together in the present embodiment.

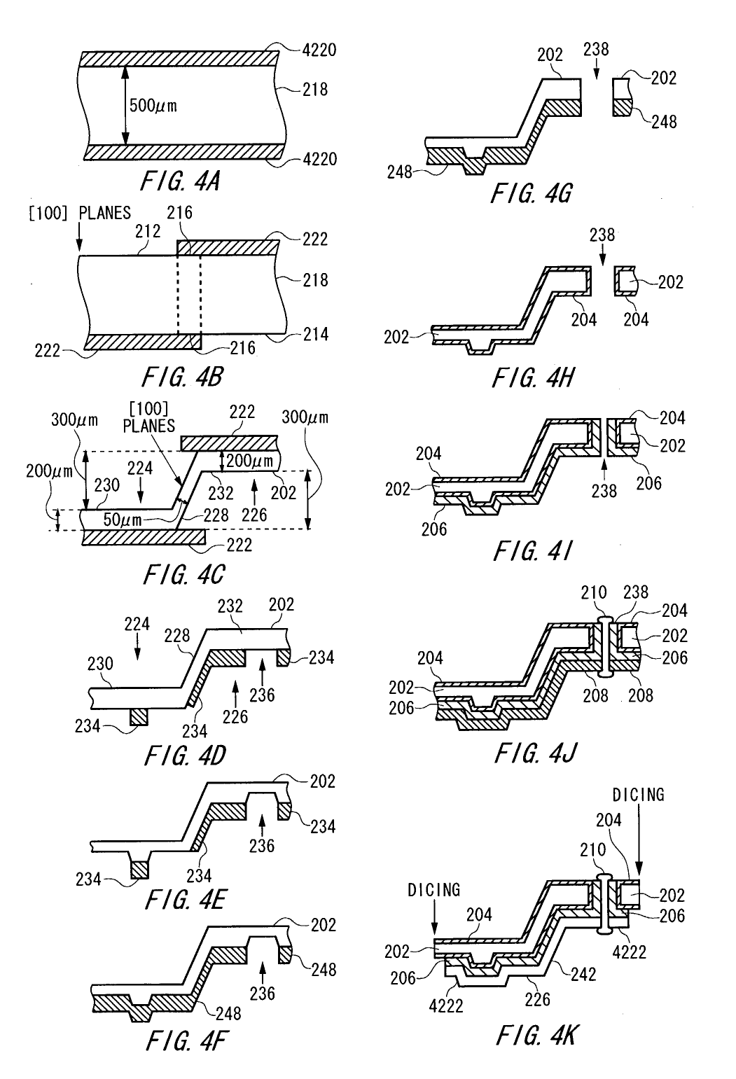

FIG. 4A to FIG. 4K are drawings exemplary showing a probe card manufacturing method of manufacturing the probe card according to the present embodiment. The manufacturing method of the probe card includes a preparation step, an elastic section formation step, a mold formation step, and a conductive section formation step.

FIG. 4A is a drawing explaining the preparation step. In the preparation step, a retention substrate 218 is provided, where the retention substrate 218 is a silicon substrate including a front surface and a back surface. In the present embodiment, overall masks 4220 are formed on both of the front and back surfaces of the substrate in the preparation step.

In the preparation step, the overall masks 4220 are formed by thermally oxidizing the front and back surfaces of the substrate. Moreover, in the present embodiment, thickness of the retention substrate 218 is about 500 micrometers. The overall masks 4220 are silicon oxide films (SiOx films). The plane directions of each of the front and back surfaces of the substrate are [100].

FIGS. 4B and 4C are drawings explaining the elastic section formation step. In the present embodiment, the elastic section formation step includes a double-sided etching mask formation step and a double-sided etching step.

FIG. 4B is a drawing explaining the double-sided etching mask formation step. In the double-sided etching mask formation step, double-sided etching masks 222 are formed by photo lithography technology. In the present embodiment, the double-sided etching masks 222 are formed by removing predetermined portions from the overall masks 4220 in the double-sided etching mask formation step. In the double-sided etching mask formation step, the portions corresponding to each of a predetermined front surface etching area 212 on the front surface of the substrate, and a predetermined back surface etching area 214 on the back surface of the substrate from the overall mask 4220, are removed.

In the present embodiment, the retention substrate 218 includes an intermediate area 216. The intermediate area 216 includes an area in the vicinity of the front surface etching area 212 on the front surface of the substrate, and an area in the vicinity of the back surface etching area 214 on the back surface of the substrate. The front and back surfaces of the intermediate area are masked by the double-sided etching mask 222.

FIG. 4C is a drawing explaining the double-sided etching step. In the double-sided etching step, the front and back surfaces of the substrate are etched using the double-sided etching masks 222 as the masks. It is preferable that the retention substrate 218 is etched by anisotropic etching in the double-sided etching step. In the present embodiment, the double-sided etching step is performed using KOH etching reagent. In another example, the double-sided etching step is performed by isotropic etching.

In the present embodiment, the retention substrate 218 is etched to a depth of 300 micrometers in the double-sided etching step. In the double-sided etching step, the retention substrate 218 is processed into a retention section 202 including a front surface corresponding to the front surface of the substrate, and a back surface corresponding to the back surface of the substrate by the etching. In the present embodiment, the double-sided etching step is a step for performing a front surface etching step and a back side etching step simultaneously.

In the front surface etching step, the front surface recess 224 is formed on the front surface by etching the retention substrate 218 from the front surface of the substrate. In the front surface etching step, the depressing section 230 is formed, which is sandwiched between a bottom surface of the front surface recess 224 and the back surface of the substrate by the etching.

By etching the retention substrate 218 from the back surface of the substrate, a back surface recess 226 is formed on the back surface of the substrate, and an elastic section 228 is formed, which is sandwiched between a side of the front surface recess 224, and a side of the back surface recess 226 in the back surface etching step. In the back surface etching step, the attachment section 232 is further formed, which is sandwiched between a bottom surface of the back surface recess 226 and the front surface of the substrate. Each of the elastic section 228, the depressing section 230, and the attachment section 232 includes a front surface corresponding to the front surface of the substrate, and a back surface corresponding to the back surface of the substrate. In addition, in the present embodiment, the plane directions of each of the side of the front surface recess 224 and the side of the back surface recess 226 are [111]. Moreover in another example, the front surface etching step and the back surface etching step are performed separately in the double-sided etching step.

FIGS. 4D to 4H are drawing explaining the mold formation step. In the mold formation step, molds for the conductive section electrically connecting the electronic device with the wiring of the wiring substrate at the probe pin are formed. In the present embodiment, a mold for the projection 244, which is explained in relation to FIG. 3, is formed on the back surface of the depressing section 230 in the mold formation step. In the mold formation step, the through tube is further formed which penetrates from the front surface to the back surface of the attachment section 232. The mold formation step includes a projection mask formation step, a projection etching step, a feedthrough mask formation step, a feedthrough etching step, and an insulator layer formation step.

FIG. 4D is a drawing explaining the projection mask formation step. In the present embodiment, the projection mask 234 is formed for masking an area corresponding to the projection 244 on the back surface of the depressing section 230 in the projection mask formation step. In the projection mask formation step, the projection mask is formed with a resist film. In the present embodiment, the projection mask 234 further masks the back surface of the elastic section 228, and predetermined portions other than the through tube formation area 236 on the back side of the attachment section 232.

FIG. 4E is a drawing explaining the projection etching step. In the projection etching step, the retention section 202 is etched from the back surface using the projection mask 234 as the mask. In the present embodiment, the back surface of the retention section 202 is etched to a depth of 20 micrometers by ICP etching in the projection etching step. In the projection etching step, the projection mask is removed after the etching.

FIG. 4F is a drawing explaining the feedthrough mask formation step. In the feedthrough mask formation step, the feedthrough mask 248 is formed for masking the portions other than the through tube formation area 236 among the back surface of the retention section 202. In the feedthrough mask formation step, the feedthrough mask 248 is formed with a resist film.

FIG. 4G is a drawing explaining the feedthrough etching step. In the feedthrough etching step, the retention section 202 is etched from the back surface using the feedthrough mask 248 as the mask. In the feedthrough etching step, the back surface of the retention section 202 is etched by ICP etching. In the feedthrough etching step, the through tube 238 is formed in the retention section 202 by the etching. In the through tube formation step, the through tube 238 is formed penetrating from the bottom surface of the back surface recess to the front surface of the substrate. In the feedthrough etching step, the feedthrough mask 248 is removed after the through tube 238 is formed.

FIG. 4H is a drawing explaining the insulating layer formation step. In the insulating layer formation step, an insulating layer 204 is formed on whole of the front and back surfaces of the retention section 202. In the insulating layer formation step, the insulating layer 204 is further formed on the innerwall of the through tube 238. In the present embodiment, a silicon oxide film is formed as the insulating layer 204 in the insulating layer formation step. In the insulating layer formation step, the silicon oxide film is formed by thermally oxidizing whole of the front and back surfaces of the retention substrate 218.

FIGS. 4I to 4K are drawing explaining the conductive section formation step. In the conductive section formation step, a conductive section is form on the back surface of the retention section 202. The conductive section formation step includes an overall metal layer formation step, a feedthrough wiring formation step, and a pattern formation step.

FIG. 4I is a drawing explaining the overall metal layer formation step. In the overall metal layer formation step, an overall metal layer 206 is formed on the back surface of the retention section 202, and the inner wall of the through tube 238. In the overall metal layer formation step, the overall metal layer 206 is formed on the insulating layer 204. For example, in the overall metal layer formation step, a layer made of gold (Au) is formed as the overall metal layer 206. In the present embodiment, the overall metal layer 206 is formed by sputtering in the overall metal layer formation step. In the overall metal layer formation step, the overall metal layer 206 with thickness of about 0.1-0.3 micrometer is formed by sputtering.

FIG. 4J is a drawing explaining a feedthrough wiring formation step. In the feedthrough wiring formation step, a feedthrough wiring 210 is formed in the through tube 238. In the feedthrough wiring formation step, the feedthrough wiring 210 is formed by filling up the through tube 238 with metal by plating. In the feedthrough wiring formation step, electrolytic plating is performed using the overall metal layer 206 as the electrode. In the present embodiment, a resist film 208, which masks the portions other than the through tube 238, is formed on the back surface of the retention section 202, and the plating is performed using the resist film 208 as the mask in the feedthrough wiring formation step. In the feedthrough wiring formation step, the resist film 208 is removed after the plating is finished.

FIG. 4K is a drawing explaining the pattern formation step. In the pattern formation step, a pattern of the conductive section is formed on the back surface of the retention section 202. In the pattern formation step, a pattern metal layer 4222 corresponding to the conductive section is formed using the resist film corresponding to the pattern as the mask. In the pattern formation step, the resist film is removed after the pattern metal layer 4222 is formed.

In the present embodiment, the pattern formation step includes a contact section formation step and a connection wiring formation step. In the pattern formation step, a contact section 226 and the conductive section, which includes the connection wiring 242 for electrically connecting the contact section 226 with the feedthrough wiring 210, are formed. In the pattern formation step, the metal layer 4222 corresponding to the conductive section is formed. In the contact section formation step, the contact section is formed at a portion corresponding to the bottom of the front surface recess on the back surface of the substrate. In the present embodiment, a plurality of contact sections are formed in the contact section formation step. Moreover, in the connection wiring formation step, the connection wiring 242 is formed for connecting the contact section 226 with the feedthrough wiring 210 electrically. In the connection wiring formation step, a plurality of connection wirings 242 are formed corresponding to the plurality of contact sections 226. In the present embodiment, the connection wiring 242 is formed from a portion corresponding to the bottom of the front surface recess of the back surface of the substrate to the bottom of the back surface recess in the connection wiring formation step.

In the present embodiment, a portion other than the area, on which the pattern metal layer 4222 is formed among the overall metal layers 206, is further removed in the pattern formation step. For example, the portion is removed by ion milling in the pattern formation step. In the pattern formation step, the retention section 202 is further diced to a predetermined size. In addition, according to the present embodiment, the probe card manufacturing method further includes a connection step. In the connection step, the feedthrough wiring 210 electrically connects with the wiring of the wiring substrate. In the connection step, the feedthrough wiring 210 electrically connects with the wiring after the pattern formation step.

According to the present embodiment, the probe card including a minute and highly accurate probe pin is manufactured by manufacturing the probe pin with photo lithography technology towards a silicon substrate. Moreover, the probe card including the probe pin having desired height and desired load is manufactured by the selection of the thickness of the retention substrate and the regulation of the amount of etching in the double-sided etching step. Furthermore, according to the present embodiment, a plurality of probe pins of the probe card are manufactured collectively. According to the present embodiment, the probe card including the plurality of probe pins having uniform height with high accuracy are manufactured.

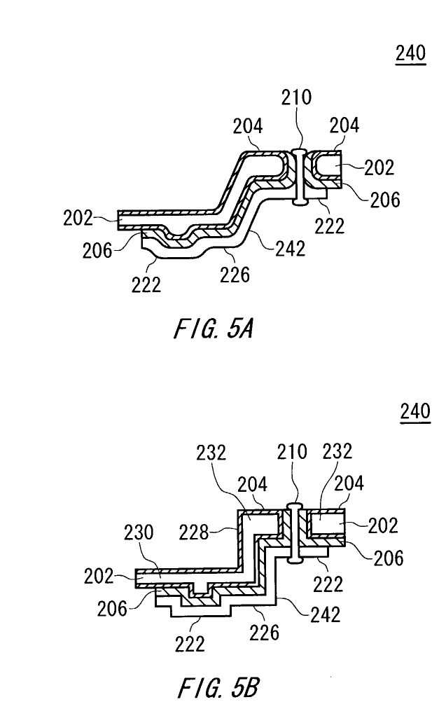

FIG. 5A and FIG. 5B are drawings showing other examples of probe pins 240 according to the present embodiment. In FIGS. 5A and 5B, the component which bears the same reference numeral as FIGS. 4A to 4K has the similar function to that of the composition in FIGS. 4A to 4K. In the example shown in FIG. 5A, the probe pin 240 includes the curved connection wiring 242. In this example, the substantially semi-spherical front surface recess and back surface recess are formed by isotropic etching in the double-sided etching step. The connection wiring 242 is formed in an area including the side of the back surface recess.

Moreover, in the example shown in FIG. 5B, the elastic section 228 substantially orthogonalizes each of the depressing section 230 and the attachment section 232. In this example, the front surface recess and back surface recess are formed by etching with strong anisotropy, such as ICP etching, so that each of the side surface substantially orthogonalizes each of the bottom surfaces respectively in the double-sided etching step. Also in these cases, the probe card including a minute and highly accurate probe pin is manufactured.

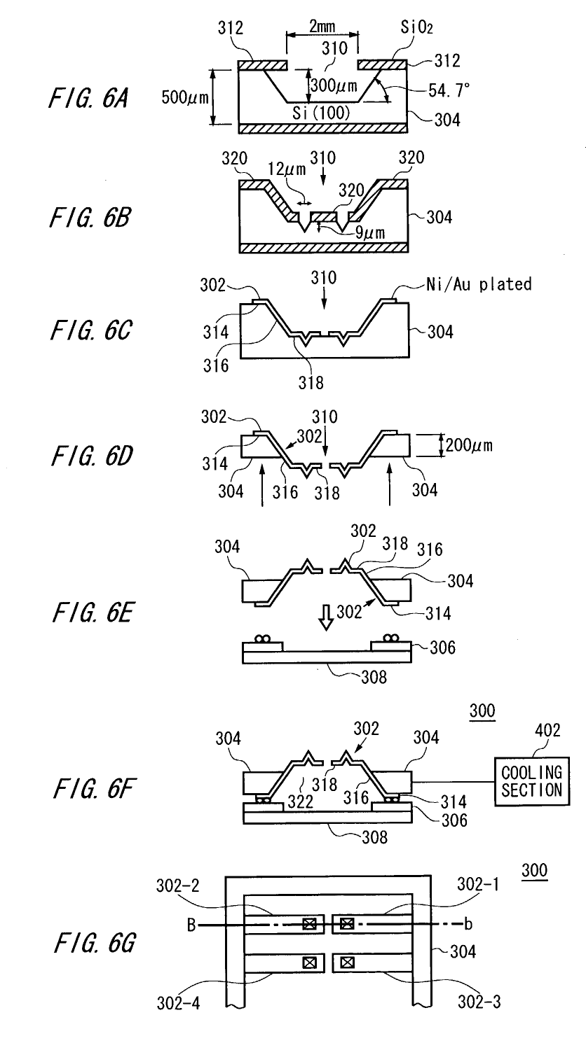

FIG. 6A to FIG. 6G are drawings exemplary showing a probe card manufacturing method according to a third embodiment of the present invention. According to the probe card manufacturing method of the present embodiment, the probe card is manufactured which includes the wiring substrate having a probe pin electrically connecting with the electronic device and the wiring electrically connecting with the probe pin. The probe card manufacturing method includes a recess formation step, a projection formation step, a conductive layer formation step, a removal step, and a bonding step.

FIG. 6A is a cross sectional view of a formation substrate 304 in the recess formation step in which the probe pin is formed. In the recess formation step, a recess 310 is formed on the surface of the formation substrate 304. In the recess formation step, a predetermined etching area on the surface of the formation substrate 304 is etched so that the recess 310 is formed. The recess formation step includes an etching mask formation step and an etching step.

In the etching mask formation step, the etching mask 312 is formed on the surface of the formation substrate 304 for masking the area other than the etching area. In the etching mask formation step, the etching mask 312 is formed by photo lithography technology. In the present embodiment, a silicon oxide film (SiOx film) is formed as the etching mask 312 in the etching mask formation step. In the etching mask formation step, the silicon oxide film is formed by thermally oxidizing the surface of the formation substrate 304. In the etching mask formation step, a portion corresponding to the etching area is removed from the silicon oxide film formed on the whole surface using photolithography technology. In addition, in the present embodiment, the silicon oxide film is formed also in the whole of the back surface of the formation substrate 304 in the etching mask formation step. Moreover, the formation substrate 304 is a silicon substrate. The plane directions of the surface of the formation substrate 304 are [100].

In the etching step, a recess 310 is formed by etching the etching area using the etching mask 312 as the mask. It is preferable that the etching area is etched by anisotropic etching in the etching step. In the present embodiment, the etching is done by KOH etching reagent in the etching step. In another embodiment, the etching is done by isotropic etching. In the etching step, the etching area is etched to a depth of about 300 micrometers. In the etching step, the recess 310 is formed which includes the bottom section substantially parallel with the surface of the formation substrate 304.

FIG. 6B is a drawing explaining the projection formation step. In the projection formation step, the mold of the projection is formed which is a portion of the probe pin in contact with the electronic device. In the projection formation step, the mold of the projection is formed by etching a part of the bottom of the recess 310. In the present embodiment, the projection formation step includes a projection formation mask formation step and a projection etching step.

In the projection formation mask formation step, the projection formation mask 320 is formed for masking a portion other than the area corresponding to the projection on the surface of the formation substrate 304 and the recess 310. In the projection formation mask formation step, a silicon oxide film is formed as the projection formation mask 320. In the projection formation mask formation step, the projection formation mask 320 is formed by photolithography technology. In the projection formation mask formation step, patterning is performed by EB exposing method to form the projection formation mask 320. Alternatively in the projection formation mask formation step, the patterning is performed by projection exposing method to form the projection formation mask 320. In the projection formation mask formation step, a silicon oxide film is formed on the whole of the back surface of the formation substrate 304.

In the projection etching step, the area corresponding to the projection is etched using the projection formation mask 320 as the mask. It is preferable that the etching is performed by anisotropic etching in the projection etching step. In the present embodiment, the etching is performed using KOH etching reagent in the projection etching step. In the projection etching step, the area corresponding to the projection is etched to a depth of about nine micrometers. In the projection etching step, the projection formation mask 320 is removed after the etching is finished. In another example, the etching is performed by isotropic etching in the projection etching step.

FIG. 6C is a drawing explaining the conductive layer formation step. In the conductive layer formation step, a conductive layer is formed from a portion in the vicinity of the recess 310 on the surface of the formation substrate 304 to the bottom of the recess 310. In the conductive layer formation step, a probe pin 302 is formed by the conductive layer. In the present embodiment, a plurality of mutually separated conductive layers are formed in the conductive layer formation step. In the conductive layer formation step, the plurality of conductive layers are formed side by side. For example, a conductive layer is formed from a part in the vicinity of the recess 310 to the bottom of the recess 310, and another conductive layer is formed from another part in the vicinity of the recess 310, which is provided across the recess 310 from the part in the vicinity of the recess 310, to the bottom of the recess 310 in the conductive layer formation step. In the conductive layer formation step, a plurality of probe pins 302 are formed by the plurality of conductive layers.

In the conductive layer formation step, the conductive layer is formed in a predetermined conductive layer area. The conductive layer area includes an attachment section area, a contact section area, and an extending section area. The attachment section area is an area in the vicinity of the recess 310 on the surface of the formation substrate 304. The attachment section area is an area corresponding to an attachment section 314, which is the portion connected to the wiring substrate at the probe pin 302. Moreover, the contact section area is a part of the bottom area of the recess 310. The contact section area is an area corresponding to the contact section 318, which is the portion holding the projection of the probe pin 302. Moreover, the extending section area is a part of the side area of the recess 310. The extending section area is an area connecting the attachment section area with the contact section area. The extending section area is an area corresponding to an extending section 316, which is the portion connecting the attachment section 314 with a contact section 318 electrically at the probe pin 302.

In the present embodiment, the conductive layer formation step includes an overall metal layer formation step, a plating mask formation step, a plating step, and an overall metal layer removal step. In the overall metal layer formation step, an overall metal layer (not shown), which is used for the electrode in the plating step, is formed on the whole surface of the recess 310 and the formation substrate 304. In the overall metal layer formation step, the overall metal layer with thickness of about 0.1-0.3 micrometer is formed by sputtering.

In the plating mask formation step, the plating mask is formed for masking the portions other than the conductive layer area on the overall metal layer. In the present embodiment, the plating mask is formed with a resist film in the plating mask formation step.

In the plating step, a conductive layer is formed on the conductive layer area by plating. In the plating step, electrolytic plating is performed using the plating mask as the mask. Alternatively, the electrolytic plating is performed using the overall metal layer as the electrode in the plating step. In the present embodiment, a nickel layer with thickness of about 10 micrometers is formed, and the gold (Au) layer with thickness of about one micrometer is formed on the nickel layer in the plating step. In the plating step, the plating mask is removed after the plating is finished.

In the overall metal layer removal step, a part of overall metal layer is removed. In the present embodiment, a portion corresponding to the plating mask among the overall metal layer is removed in the overall metal layer removal step. In the overall metal layer removal step, the portion is removed by ion milling.

In addition, in another example, the conductive layer is formed by sputtering in the conductive layer formation step. In this case, it is preferable to form a sputtering mask with a resist film for example, and to perform the sputtering using the sputtering mask as the mask in the conductive layer formation step.

FIG. 6D is a drawing explaining the removal step. In the removal step, the formation substrate 304 is etched from the back surface, so that the conductive layer formed on the bottom of the recess 310 is exposed. In the removal step, at least a part of the formation substrate 304 is removed by the etching. In the removal step, it is preferable to exposes at least a part of the conductive layer formed on the side of the recess 310. In the removal step, the contact section 318 of the probe pin 302 is exposed by the etching. For example, ICP etching is performed in the removal step.

FIG. 6E is a drawing explaining the bonding step. In the bonding step, the attachment section 314 of the probe pin 302 is bonded to a wiring 306 of a wiring substrate 308. In the bonding step, the bonding is done by the thermo compression bonding between the attachment section 314 and the wiring 306. The wiring 306 includes a pad on the surface bonded to the attachment section 314. For example, the pad is a Ti/Au pad. It is preferable that the pad includes an Au solder ball. In this case, the attachment section 314 and the wiring 306 are bonded across the solder ball from each other. In the bonding step, the attachment section 314, which is the conductive layer formed in the vicinity of the recess, is bonded to the wiring 306.

FIG. 6F is a cross sectional view of a probe card 300 according to the present embodiment. The probe card 300 includes the wiring substrate 308, the formation substrate 304, and the plurality of probe pins 302. The wiring substrate 308 includes a plurality of wiring 306 corresponding to the plurality of probe pins 302 respectively. The formation substrate 304 holds the plurality of probe pins 302. In the present embodiment, the formation substrate 304 includes a through tube 322, and contacts with the plurality of probe pins 302 on the surface of the through tube 322. Each of the plurality of probe pins 302 includes the attachment section 314, the extending section 316, and the contact section 318. Each of the attachment sections 314, the extending section 316, and the contact sections 318 has substantially the same thickness as each other. The attachment section 314 is formed in the vicinity of the opening of the through tube 322 on the surface of the formation substrate 304. The extending section 316 is formed extending from the attachment section 314 along the surface of the through tube 322. In the present embodiment, the extending section 316 extends over the opening of the through tube 322 on the back surface of the formation substrate 304. The contact section 302 is formed extending from the extending section 316 substantially parallel with the back surface of the formation substrate 304.

Moreover, in the present embodiment, the probe card 300 further includes a cooling section 402. The cooling section 402 cools the formation substrate 304. For example, the cooling section 402 cools the formation substrate 304 by letting water flow in a pipe being in contact with the formation substrate 304. The cooling section 402 cools the probe pin 302 through the formation substrate 304. It is preferable that the formation substrate 304 has high thermal conductivity. Thereby, the temperature of the probe pin 302 is maintained in a suitable temperature span. For example, the cooling section 402 is a radiator being in contact with the formation substrate 304.

FIG. 6G is a top view of the probe card according to the present embodiment. In the present embodiment, the formation substrate 304 holds the plurality of probe pins (302-1 to 302-4). Alternatively the formation substrate 304 further holds more probe pins 302 than the example described above. In addition, FIG. 6F is a cross sectional view taken along an alternate long and short dash line B-b of FIG. 6G.

According to the present embodiment, the probe card with minute and highly accurate probe pin is manufactured by manufacturing the probe pin with photo lithography technology towards a silicon substrate. Moreover, according to the present embodiment, the probe pin with desired height is manufactured by regulating the amount of etching in the recess formation step. Moreover, the probe pin with desired load is manufactured by selecting material of the conductive layer being laminated in the conductive layer formation step, and regulating the amount of the lamination. Furthermore, according to the present embodiment, a plurality of probe pins for a probe card are manufactured collectively.

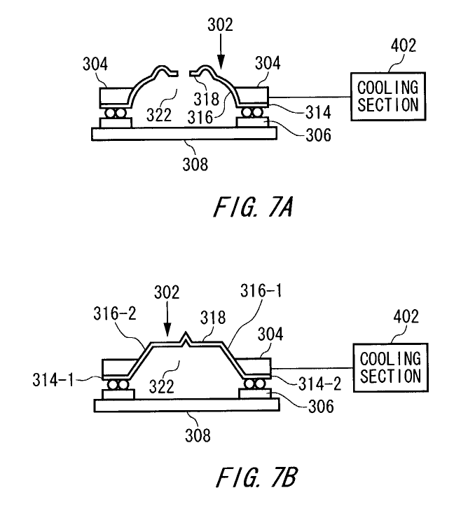

FIG. 7A and FIG. 7B are drawings showing other examples of the probe card 300 according to the present embodiment. In FIGS. 7A and 7B, the component which bears the same reference numeral as FIGS. 6A to 6G has the similar function to that of the component in FIGS. 6A to 6G. In the example shown in FIG. 7A, the probe pin 302 includes the curved extending section 316. In this example, in the etching step of the recess formation step, the substantially semi-spherical recess is formed by isotropic etching. The conductive layer corresponding to the extending section 316 is formed on the side of the recess. Moreover, the contact section 318 includes substantially semi-spherical projections.

Moreover, in the example shown in FIG. 7B, the probe pin 300 includes a plurality of attachment sections (314-1,314-2) and a plurality of extending sections (316-1,316-2) corresponding to one contact section 318. An end of the contact section 318 electrically connects with an end of the extending section 316-1. Another end of the extending section 316-1 electrically connects with an end of the attachment section 314-1. Moreover, another end of the contact section 318 electrically connects with an end of the extending section 316-2. Another end of the extending section 316-2 electrically connects with an end of the attachment section 314-2. In this example, in the conductive layer formation step, the conductive layer is formed extending from a portion in the vicinity of the recess 310 explained in relation to FIG. 6 on the surface of the formation substrate 304, to another portion in the vicinity of the recess 310 over the bottom of the recess 310. Also in this case, the probe card with a minute and highly accurate probe pin is manufactured.

As described above, according to the present invention, there is provided a prove card having a minute and highly accurate prove.

Although the present invention has been described by way of an exemplary embodiment, it should be understood that those skilled in the art might make many changes and substitutions without departing from the spirit and the scope of the present invention. It is obvious from the definition of the appended claims that embodiments with such modifications also belong to the scope of the present invention.

What is claimed is:

1. A probe card electrically connecting with an electronic device, comprising:
a probe pin electrically connecting with the electronic device; and
a wiring substrate comprising a wiring electrically connecting with said probe pin,
wherein said probe pin comprises:
a first end electrically connecting with said wiring;
a contact section extending from said first end to a direction away from said wiring substrate, said contact section being formed to oppose said wiring substrate and electrically connecting with the electronic device;
a second end extending from said contact section and electrically connecting with said wiring; and
a hollow section formed in an area sandwiched between said wiring substrate and said contact section.

2. The probe card as claimed in claim 1, wherein said probe pin comprises:
a conductive layer including said first end, said contact section and said second end, which are integrated together; and
an elastic conductive layer substantially covering a back surface of a surface opposing said wiring substrate of said conductive layer.

3. A probe card manufacturing method of manufacturing a probe card comprising a probe pin electrically connecting with an electronic device, and a wiring substrate including a wiring electrically connecting with the probe pin, the prove card manufacturing method comprising steps of:
forming a recess on a surface of the formation substrate on which the probe pin is formed;
forming a conductive layer in the recess and a portion in the vicinity of the recess on the surface of the formation substrate;
bonding the wiring to the conductive layer formed on the surface of the formation substrate; and
removing the formation substrate.

4. The probe card manufacturing method as claimed in claim 3, further comprising a step of forming an elastic conductive layer in the recess, wherein
the conductive layer is formed on the elastic conductive layer in said conductive layer formation step.

5. The probe card manufacturing method as claimed in claim 3, wherein
the plurality of recesses are formed in said recess formation step, and
the plurality of mutually separated conductive layers, which respectively correspond to the plurality of recesses, are formed in said conductive layer formation step.

6. A contact electrically connecting a wiring substrate including a wiring with a conductor, comprising:
a first end electrically connecting with the wiring;
a contact section extending from said first end to a direction away from the wiring substrate, said contact section being formed to oppose the wiring substrate and electrically connecting with the conductor;
a second end extending from said contact section and electrically connecting with the wiring; and
a hollow section formed in an area sandwiched between the wiring substrate and said contact section.

7. A probe card comprising a probe pin electrically connecting with an electronic device, wherein
the probe pin comprises:
a contact section electrically connecting with the electronic device; and
an elastic section, having elasticity in a direction in which said contact section contacts the electronic device, and holding said contact section, said elastic section being made of silicon.

8. The probe card as claimed in claim 7, further comprising a wiring substrate including a wiring electrically connecting with the probe pin, wherein
said elastic section comprises an end, and another end, which is spaced apart from said wiring substrate, and
the probe pin comprises:
an attachment section extending from said end of said elastic section substantially parallel with said wiring substrate, and connecting with said wiring substrate; and
a depressing section extending from said other end of said elastic section to a direction opposite from said attachment section substantially parallel with said wiring substrate, said depressing section holding said contact section on a back surface of a surface opposing said wiring substrate.

9. The probe card as claimed in claim 7, further comprising a plurality of probe pins.

10. A probe card comprising a probe pin electrically connecting with an electronic device, wherein
the probe pin comprises:
a plurality of contact sections electrically connecting with the electronic device; and
an elastic section, having elasticity in a direction in which said plurality of contact sections contact the electronic device, and holding said plurality of contact sections.

11. A probe card manufacturing method of manufacturing a probe card comprising: a contact section electrically connecting with the electronic device; and an elastic section, having elasticity in a direction in which said contact section contacts the electronic device, and holding said contact section, the prove card manufacturing method comprising steps of:
preparing a the silicon substrate including a front substrate surface and a back substrate surface;
forming a front surface recess on the front substrate surface by etching the silicon substrate from the front substrate surface;
forming a back surface recess on the back substrate surface by etching the silicon substrate from the back substrate surface, and forming the elastic section sandwiched between a side of the front surface recess and a side of the back surface recess; and
forming the contact section at a portion corresponding to bottom of the front surface recess on the back substrate surface.

12. The probe card manufacturing method as claimed in claim 11, wherein said front surface etching step and said back surface etching step are performed simultaneously.

13. the probe card manufacturing method as claimed in claim 11, wherein
the probe card further comprises a wiring substrate including a wiring electrically connecting with the probe pin, and
the probe card manufacturing method further comprises steps of:
forming a through tube penetrating from bottom of the back surface recess to the front substrate surface;
forming a feedthrough wiring in the through tube;
forming a connection wiring provided over the back substrate surface from a portion corresponding to bottom of the front surface recess to the bottom of the back surface recess, the connection wiring connecting the contact section with the feedthrough wiring electrically; and
connecting electrically the feedthrough wiring with the wiring of the wiring substrate.

14. The probe card manufacturing method as claimed in claim 11, wherein a plurality of contact sections are formed in said contact section formation step.

15. A probe card manufacturing method of manufacturing a probe card comprising a probe pin electrically connecting with an electronic device, the probe card manufacturing method comprising steps of:
forming a recess on a surface of a formation substrate on which the probe pin is formed;
forming a conductive layer from a portion in the vicinity of the recess to bottom of the recess on the surface of the formation substrate; and
exposing the conductive layer formed on the bottom of the recess by etching the formation substrate from a back surface.

16. The probe card manufacturing method as claimed in claim 15, wherein a plurality of said conductive layers, which are separated mutually, are formed in said conductive layer formation step.

17. The probe card manufacturing method as claimed in claim 15, wherein
the probe card further comprises a wiring substrate including a wiring electrically connecting with the probe pin, and
the probe card manufacturing method further comprises a step of bonding the conductive layer formed in the vicinity of the recess to the wiring.
